(19) United States
(12) Patent Application Publication
(10) Pub. No.: US 2007/0164011 A1
(43) Pub. Date: Jul. 19, 2007

(54) Heater for extreme convex mirrors or irregular shapes

(76) Inventor: Edward F. Bulgajewski, Genoa, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/637,474

(22) Filed: Dec. 12, 2006

Related U.S. Application Data
(60) Provisional application No. 60/758,804, filed on Jan. 13, 2006.

(51) Int. Cl. H05B 3/00

(52) U.S. Cl. 219/219

(57) ABSTRACT

A heater for a non-planar mirror may be provided on a polymer substrate that has been cut to allow flexible movement in the x, y and z axes, for example, by cutting the substrate in a generally long, narrow s-shape. By allowing flexible movement and overlapping on itself when attached to a non-planar surface, uniform adhesion is achieved over substantially the entire surface to be heated. In aspects of the invention, the heater may be screen printed on the substrate and have electrical connections attached at opposite ends of the substrate to provide comparable current flow paths across essentially the full heater surface.

### CROSS REFERENCE TO RELATED APPLICATIONS

This Non-Provisional Application claims benefit to U.S. Provisional Application Ser. No. 60/758,804 filed Jan. 13, 2006.

### FIELD OF THE INVENTION

The present invention relates generally to heaters for mirror surfaces that are non-planar in shape and more particularly to heaters for extreme convex shaped mirrors.

### BACKGROUND OF THE INVENTION

It is known that extreme convex mirrors are used to provide a wide field of view. Such extreme convex mirrors are used, for example, on school buses and on security vehicles for surveillance purposes, among other uses. The known extreme convex mirrors may have an approximately a six-inch radius.

It is also known that mirror heaters are used to heat the surfaces of the mirror to defrost or melt any snow, ice or condensation that may accumulate on the mirror surface to thereby improve the use and function of the mirror. These mirror heaters are designed for and typically are used on flat, or planar, mirror surfaces. Attempts have been made to also use these mirror heaters on extreme convex mirrors, however, with little success. In fact, there are several known drawbacks with the application of the known mirror heaters to the extreme convex mirrors. For example, in order to attach the known mirror heater to the inside concave surface of the extreme convex mirror, the mirror heater must be stretched, pulled, expanded and sometimes contracted so that the mirror heater can adequately attach to the non-planar, concave surface. The known mirror heater must be distorted in the x, y, and z axes, sometimes causing the heater to buckle, crease, wrinkle and/or peel. In some instances, as the mirror heater becomes distorted, the conductive layer of the heater may not function properly.

In an attempt to improve the attachment of the known mirror heaters to an extreme convex mirror, the heaters have been designed with slots, fan shaped apertures, and the like. However, little or no improvement has been achieved in adhesion due to a combined lack of flexibility in the x, y and z axes. In some cases, these heaters have completely delaminated from the mirror surface, sometimes also damaging the mirror itself by de-chroming the mirror. The de-chroming results from the lack of flexibility of the mirror heater which can cause a high sheer force between the heater substrate and the adhesive attached to the mirror surface. Other heater designs are known that are configured to leave gaps in the heater in an attempt to accommodate the convex mirror shape. However, these gaps result in inefficient surface heating of the mirror. In fact, hot and cold spots may result that cause the mirror surface to not defrost completely.

The present invention addresses these and other known drawbacks with existing heaters for extreme convex mirrors or irregular shaped mirrors.

### SUMMARY OF THE INVENTION

The present invention relates to a heater for surfaces that are non-planar in shape and for extreme convex mirrors. Embodiments of the invention provide a heater on a polymer substrate that has been cut to allow flexible movement in all three axes of direction—the x, y and z axes. With the invention, uniform adhesion and heating is achieved over substantially the entire surface to be heated. In aspects of the invention, the heater may have electrical connections attached at opposite ends to provide comparable current flow paths across the full heater surface.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1a is a top plan view of the shape of the substrate of a heating device of an embodiment of the present invention.

FIG. 1b is a top plan view of the heating device of FIG. 1a.

FIG. 2 is a perspective view of an embodiment of the invention adhered to the inner surface of an exemplary extreme convex mirror.

FIG. 3 is a perspective view of the outer surface of the exemplary extreme convex mirror of FIG. 2.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

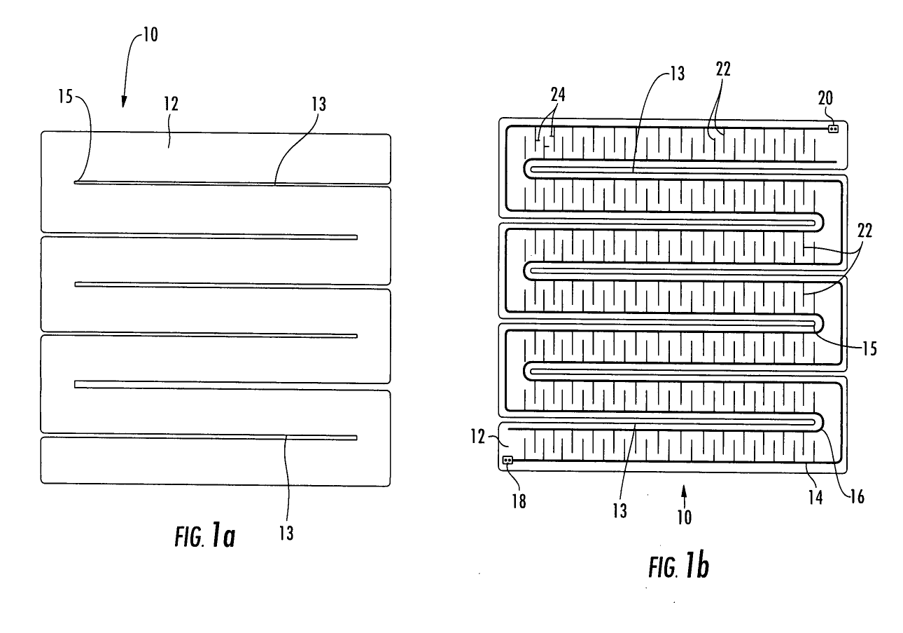

The present invention may be embodied in many forms, some of which are illustrated by the Figures. Referring to FIG. 1a, in one aspect of the invention, a heating device 10 is illustrated showing a substrate 12 cut into a continuous, generally s-shaped, snake design. In other words, the substrate 12 may be cut into a generally long, generally narrow continuous material having a plurality of generally linear sections connected at alternating ends to substantially cover an area. Slits 13 are formed between the linear sections. The slits 13 may be linear or alternatively non-linear. The slits 13 may define ends 15 that further define a radius to prevent tearing or ripping of the substrate. The configuration of the heating device 10 depicted in FIG. 1a, provides a heating device 10 that allows flexible, bendable movement in all three axes of direction—the x, y and z axes. With this configuration, uniform adhesion and heating is achieved over substantially the entire surface to be heated, including extreme convex shaped mirror surfaces or other irregular shaped surfaces. It should be understood that the invention is not limited to the heater configuration illustrated in FIGS. 1a, 1b, that other configurations are contemplated that still provide a heating device that allows flexible movement in all three axes of direction and provide uniform adhesion and heating across the entire surface to be heated.

The substrate 12 may be made of an electrically insulative material in the form of a thin film having, for example, a thickness generally within the range of 0.004 to 0.010 inches, though other film thicknesses are possible. The substrate 12 may be made of a polymer sheet, for example a polyester sheet such as Mylar®, on which a heater may be disposed.

Referring to FIG. 1b, disposed on the surface of the substrate 12 is a conductive layer forming at least one bus 14. Two busses 14 and 16 may be used, extending generally along the longitudinal edges from one end of the substrate 12 to the opposing end. The heating device 10 may be configured to include a positive electrical connection 18 disposed at one end of the substrate 12 on bus 14, and a negative electrical connection 20 disposed at the opposite end of the substrate 12 on bus 16. An opposite end electrical connection allows equivalent current flow paths across the surface of the heater, preventing excessive cumulative resistance that may undesirably reduce the power along the length of substrate 12. It should be understood that other numbers and configurations of busses and their electrical connections are possible and may be used with the various aspects of the invention.

To provide uniform heating across the heating device 10, numerous traces 22 may extend outwardly from the busses 14, 16 to distribute the heat across the entire heater. In an alternative aspect of the invention, at least some of the traces 22 may include spurs 24 extending outwardly toward the next adjacent trace 22. Additionally, at least some of these spurs may include branches (not shown) extending in a variety of directions to more fully cover the substrate 12 and distribute heat.

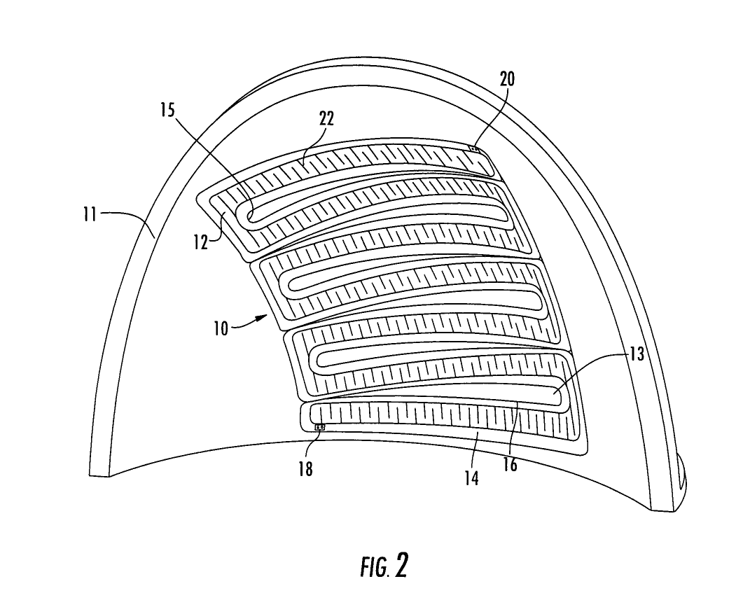

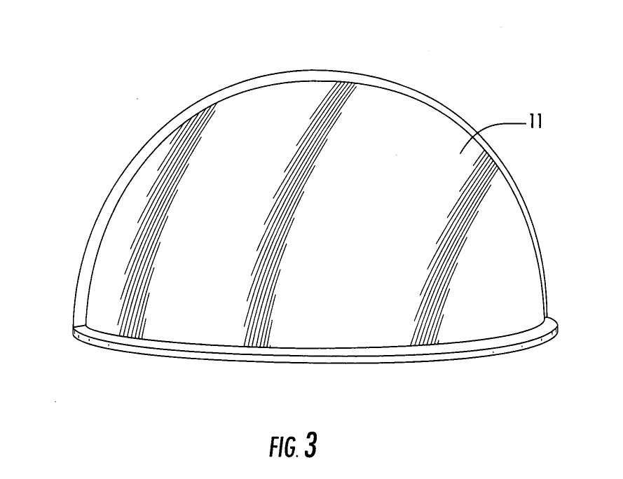

Referring to FIG. 2, an embodiment of the heating device 10 is shown attached to the back concave surface of an exemplary extreme convex mirror 11. FIG. 2 shows how the configuration of substrate 12 allows the device 10 to be effectively adhered to the surface of the mirror 11 without the undesirable buckling, creasing or wrinkling of the substrate. The ability of the device 10 to overlap on itself, for example at the curves of the s-shape, while attached to a non-planar surface is also illustrated in FIG. 2. This overlap results in complete heater coverage across the mirror surface resulting in complete and uniform heating of the mirror surface. FIG. 3 displays the front surface of the exemplary extreme convex mirror 11 of FIG. 2.

One skilled in the art will understand that flexible heaters may include electrical conductors that are typically made from a conductive metal such as copper, silver, gold, aluminum, carbon, or graphitic materials. It is further known that the conductive material used as the electrical conductor may be made of very small flakes of material in a polymer matrix.

Returning back to FIG. 1b, a resistive layer may be disposed on the conductive layer of the substrate 12, such that when an electrical power source is connected to the bus structure in the conductive layer, heat is generated. The resistive layer may include a positive temperature coefficient (PTC) material to provide an increasing resistance in response to an increasing temperature, known as a self-regulating heater, or it may include a fixed resistance element which may be connected to an electronic controller to regulate the heat level. The resistive layer may be comprised of a polymer thick film.

In an alternative aspect of the invention, a dielectric film may be applied between the substrate 12 and the conductive layer to improve chemical resistance and durability of the device 10. For example, the dielectric film may be a polyester film with a polyester adhesive. Additionally, other types of films, such as nylon polyolefin and polyimide, may be used as well as other types of adhesives such as epoxy and acrylics. The dielectric film, which effectively functions as a laminate, protects the surface of the conductive layer by preventing the conductive materials, for example silver and carbon black, from being removed by contact and abrasion during handling or use. The laminate can further help reduce or eliminate cracking of the conductive layer, thereby extending the life of the device 10.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art. Various features of the invention are set forth in the following claims.

What is claimed is:

1. A heating device for non-planar mirror surfaces comprising:
a polymer sheet substrate defining a continuous generally s-shaped configuration; and
a heater screen printed on a surface of the substrate, the heater comprising at least one electrical bus extending the length of the substrate and having a positive electrical connection near a first end of the substrate and a negative electrical connection near a second end of the substrate.

2. The heating device of claim 1 wherein the heater further comprises a positive temperature coefficient material.

3. The heating device of claim 1 wherein the heater further comprises electrical traces extending from the at least one bus to substantially cover the surface area of the substrate.

4. The heating device of claim 3 wherein the traces comprise conductive material flakes mixed with a conductive polymer.

5. The heating device of claim 1 wherein the at least one electrical bus comprises a conductive polymer and a material chosen from the group consisting of copper, gold, silver, aluminum, carbon, and graphitic materials.

6. The heating device of claim 1 wherein the substrate defines a thickness between approximately 0.004 inches and 0.010 inches.

7. The heating device of claim 1 wherein the substrate comprises polyester.

8. A heating device for non-planar mirror surfaces comprising:
a substrate, the substrate cut to provide a generally long, generally narrow continuous material having a plurality of generally linear sections connected at alternating ends to substantially cover an area; and
a heater disposed on a surface of the substrate, the heater comprising at least one electrical bus that extends essentially the full length of the substrate, the at least one bus including a plurality of traces extending radially to substantially cover the surface of the substrate.

9. The heating device of claim 8 wherein the heater is connected at a first end with a positive electrical connection and at a second end with a negative electrical connection.

10. The heating device of claim 8 further comprising a chemical resistive laminate disposed on the heater.

11. The heating device of claim 8 wherein the substrate may overlap itself when attached to the non-planar surface.

12. The heating device of claim 8 wherein the heater further comprises a positive temperature coefficient material.

13. The heating device of claim 8 wherein the at least one electrical bus comprises a conductive polymer and a material chosen from the group consisting of copper, gold, silver, aluminum, carbon, and graphitic materials.

14. The heating device of claim 8 wherein the substrate comprises polyester.

15. A heating device for non-planar mirror surfaces comprising:
a polyester substrate cut into a continuous, generally narrow shape to allow flexing and overlapping during disposition of the substrate on the non-planar surface, the substrate substantially covering an area of the non-planar surface with generally uniform adhesion; and
a heater screen printed on a surface of the substrate, the heater comprising:
a conductive layer including a first bus and a second bus, the first and second busses disposed generally along a first and a second longitudinal edge of the substrate, and a plurality of traces extending from the first and second busses to distribute heat over the surface of the substrate;
a positive electrical connection disposed at an end of the first bus and a negative electrical connection disposed at an opposing end of the second bus; and
a resistive layer disposed on the conductive layer, the resistive layer comprising a thick polymer film.

16. The heating device of claim 15 wherein the traces comprise conductive material flakes mixed with a conductive polymer.

17. The heating device of claim 15 wherein at least some of the traces comprise spurs extending outwardly from the traces.

18. The heating device of claim 15 wherein the resistive layer comprises a positive temperature coefficient material.

19. The heating device of claim 15 wherein the first and second electrical busses comprise a conductive polymer and a material chosen from the group consisting of copper, gold, silver, aluminum, carbon, and graphitic materials.

20. The heating device of claim 15, wherein the substrate defines a thickness between approximately 0.004 inches and 0.010 inches.
